(19) United States
(12) Patent Application Publication
(10) Pub. No.: US 2009/0276496 A1
(43) Pub. Date: Nov. 5, 2009

(54) SYSTEMS, METHODS AND COMPUTER PROGRAM PRODUCTS FOR BUILDING A USER'S BUDDY LIST THROUGH PUBLIC GROUP MEMBERSHIP

(75) Inventors: Christina M. Cruz, Mableton, GA (US); Charles B. Price, JR., Decatur, GA (US); Van T. Staub, II, Smyrna, GA (US)

Correspondence Address: CANTOR COLBURN LLP - IBM LOTUS, 20 Church Street, 22nd Floor, Hartford, CT, 06103, US

(73) Assignee: INTERNATIONAL BUSINESS MACHINES CORPORATION, Armonk, NY (US)

(21) Appl. No.: 12/112,015

(22) Filed: Apr. 30, 2008

(51) Int. Cl. G06F 15/16

(52) U.S. Cl. 709/206

(57) ABSTRACT

Systems, methods and computer program products for hardware assists for building a user's buddy list through public group membership. Exemplary embodiments include identifying a member from the user's buddy list, identifying a skill possessed by the member of the user's buddy list, searching for a group having the skill, selecting the member from the user's buddy list, sending a request to an instant messaging server to obtain a list having all the public groups for the member, receiving a response from the instant messaging server, the response including the list having the public groups for the member, selecting from the list of public group including members that have the skill and performing at least one of adding the public group to a contact list and searching for additional public groups based on users included in the list of public groups of the member.

### TRADEMARKS

IBM® is a registered trademark of International Business Machines Corporation, Armonk, N.Y., U.S.A. Other names used herein may be registered trademarks, trademarks or product names of International Business Machines Corporation or other companies.

### BACKGROUND OF THE INVENTION

1. Field of the Invention

This invention relates to IM buddy lists, and particularly to systems, methods and computer program products for building a user's buddy list through public group membership.

2. Description of Background

An instant messaging (IM) system includes public groups that contain users in the system and allows for the addition of the group, encompassing users to a contact list. In current IM systems, a given system requires prior knowledge of a group name or identifier before the addition of a group.

### SUMMARY OF THE INVENTION

Exemplary embodiments include a method in a computer system having a display, the method for building a user's buddy list through a public group membership and including identifying a member from the user's buddy list, identifying a skill possessed by the member of the user's buddy list, searching for a group having the skill, selecting the member from the user's buddy list, requesting that all public groups in which the member belongs, be displayed on the display, including sending a request to an instant messaging server to obtain a list having all the public groups for the member, wherein the instant message server is configured to query a Lightweight Directory Assistance Protocol server to obtain the list having the public groups for the member, the query to the Lightweight Directory Assistance Protocol Server being in the form, Ldapsearch -h<hostname><filter><attributes to return>, receiving a response from the instant messaging server, the response including the list having the public groups for the member, selecting from the list of public group including members that have the skill and performing at least one of adding the public group to a contact list and searching for additional public groups based on users included in the list of public groups of the member.

System and computer program products corresponding to the above-summarized methods are also described and claimed herein.

Additional features and advantages are realized through the techniques of the present invention. Other embodiments and aspects of the invention are described in detail herein and are considered a part of the claimed invention. For a better understanding of the invention with advantages and features, refer to the description and to the drawings.

### TECHNICAL EFFECTS

As a result of the summarized invention, technically we have achieved a solution which includes the ability to locate public groups based on existing known contacts. The public groups can then be added or traversed to locate new contacts or public groups.

### BRIEF DESCRIPTION OF THE DRAWINGS

The subject matter which is regarded as the invention is particularly pointed out and distinctly claimed in the claims at the conclusion of the specification. The foregoing and other objects, features, and advantages of the invention are apparent from the following detailed description taken in conjunction with the accompanying drawings in which:

FIG. 1 illustrates an exemplary embodiment of a system for building a user's buddy list through public group membership; and

FIG. 2 illustrates a flow chart of a method 200 for building a user's buddy list through public group membership.

The detailed description explains the preferred embodiments of the invention, together with advantages and features, by way of example with reference to the drawings.

### DETAILED DESCRIPTION OF THE INVENTION

In exemplary embodiments, the systems and methods described herein locate public IM groups based on an individual contact that allows the user to easily build contact lists and aids in discovery of new contacts. In exemplary embodiments, the user is thus able to easily add public groups and possibly locate similar contacts to the original known contact. In exemplary embodiments, the group returned from a search based on a user contains users that can then be searched to find the public groups they are members. This traversal process can be carried out iteratively to locate new contacts.

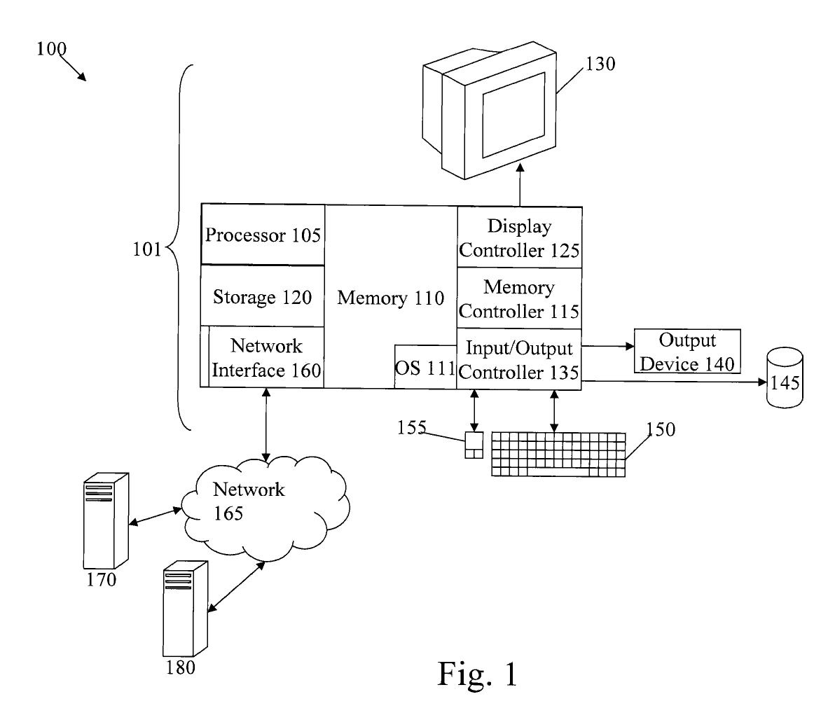

FIG. 1 illustrates an exemplary embodiment of a system 100 for building a user's buddy list through public group membership. The methods described herein can be implemented in software (e.g., firmware), hardware, or a combination thereof. In exemplary embodiments, the methods described herein are implemented in microcode, as an executable routine that is executed by a special or general-purpose digital computer, such as a personal computer, workstation, minicomputer, or mainframe computer. The system 100 therefore includes general-purpose computer 101.

In exemplary embodiments, in terms of hardware architecture, as shown in FIG. 1, the computer 101 includes a processor 105, memory 110 coupled to a memory controller 115, and one or more input and/or output (I/O) devices 140, 145 (or peripherals) that are communicatively coupled via a local input/output controller 135. The input/output controller 135 can be, for example but not limited to, one or more buses or other wired or wireless connections, as is known in the art. The input/output controller 135 may have additional elements, which are omitted for simplicity, such as controllers, buffers (caches), drivers, repeaters, and receivers, to enable communications. Further, the local interface may include address, control, and/or data connections to enable appropriate communications among the aforementioned components.

The processor 105 is a hardware device for executing software, particularly that stored in memory 110. The processor 105 can be any custom made or commercially available processor, a central processing unit (CPU), an auxiliary processor among several processors associated with the computer 101, a semiconductor based microprocessor (in the form of a microchip or chip set), a macroprocessor, or generally any device for executing software instructions. It is appreciated that the processor 105 can include a plurality of registers including GPRs, FPRs, scratch registers, etc.

The memory 110 can include any one or combination of volatile memory elements (e.g., random access memory (RAM, such as DRAM, SRAM, SDRAM, etc.)) and nonvolatile memory elements (e.g., ROM, erasable programmable read only memory (EPROM), electronically erasable programmable read only memory (EEPROM), programmable read only memory (PROM), tape, compact disc read only memory (CD-ROM), disk, diskette, cartridge, cassette or the like, etc.). Moreover, the memory 110 may incorporate electronic, magnetic, optical, and/or other types of storage media. Note that the memory 110 can have a distributed architecture, where various components are situated remote from one another, but can be accessed by the processor 105.

The software in memory 110 may include one or more separate programs, each of which comprises an ordered listing of executable instructions for implementing logical functions. In the example of FIG. 1, the software in the memory 110 includes the buddy list generation methods described herein in accordance with exemplary embodiments and a suitable operating system (OS) 111. The operating system 111 essentially controls the execution of other computer programs, such the buddy list generation systems and methods described herein, and provides scheduling, input-output control, file and data management, memory management, and communication control and related services.

The buddy list generation methods described herein may be in the form of a source program, executable program (object code), script, or any other entity comprising a set of instructions to be performed. When a source program, then the program needs to be translated via a compiler, assembler, interpreter, or the like, which may or may not be included within the memory 110, so as to operate properly in connection with the OS 111. Furthermore, the buddy list generation methods can be written as an object oriented programming language, which has classes of data and methods, or a procedure programming language, which has routines, subroutines, and/or functions.

In exemplary embodiments, a conventional keyboard 150 and mouse 155 can be coupled to the input/output controller 135. Other output devices such as the I/O devices 140, 145 may include input devices, for example but not limited to a printer, a scanner, microphone, and the like. Finally, the I/O devices 140, 145 may further include devices that communicate both inputs and outputs, for instance but not limited to, a network interface card (NIC) or modulator/demodulator (for accessing other files, devices, systems, or a network), a radio frequency (RF) or other transceiver, a telephonic interface, a bridge, a router, and the like. The system 100 can further include a display controller 125 coupled to a display 130. In exemplary embodiments, the system 100 can further include a network interface 160 for coupling to a network 165. The network 165 can be an IP-based network for communication between the computer 101 and any external server, client and the like via a broadband connection. The network 165 transmits and receives data between the computer 101 and external systems. In exemplary embodiments, network 165 can be a managed IP network administered by a service provider. The network 165 may be implemented in a wireless fashion, e.g., using wireless protocols and technologies, such as WiFi, WiMax, etc. The network 165 can also be a packet-switched network such as a local area network, wide area network, metropolitan area network, Internet network, or other similar type of network environment. The network 165 may be a fixed wireless network, a wireless local area network (LAN), a wireless wide area network (WAN) a personal area network (PAN), a virtual private network (VPN), intranet or other suitable network system and includes equipment for receiving and transmitting signals.

As further described herein, an IM server 170 is communicatively coupled to the network 165. In addition, a directory server 180 is further communicatively coupled to the network 165. In exemplary embodiments, the directory server 180 can be a Lightweight Directory Assistance Protocol (LDAP) server as further described herein.

If the computer 101 is a PC, workstation, intelligent device or the like, the software in the memory 110 may further include a basic input output system (BIOS) (omitted for simplicity). The BIOS is a set of essential software routines that initialize and test hardware at startup, start the OS 111, and support the transfer of data among the hardware devices. The BIOS is stored in ROM so that the BIOS can be executed when the computer 101 is activated.

When the computer 101 is in operation, the processor 105 is configured to execute software stored within the memory 110, to communicate data to and from the memory 110, and to generally control operations of the computer 101 pursuant to the software. The buddy list generation methods described herein and the OS 111, in whole or in part, but typically the latter, are read by the processor 105, perhaps buffered within the processor 105, and then executed.

When the systems and methods described herein are implemented in software, as is shown in FIG. 1, it the methods can be stored on any computer readable medium, such as storage 120, for use by or in connection with any computer related system or method. In the context of this document, a computer readable medium is an electronic, magnetic, optical, or other physical device or means that can contain or store a computer program for use by or in connection with a computer related system or method. The buddy list generation methods described herein can be embodied in any computer-readable medium for use by or in connection with an instruction execution system, apparatus, or device, such as a computer-based system, processor-containing system, or other system that can fetch the instructions from the instruction execution system, apparatus, or device and execute the instructions. In exemplary embodiments, a “computer-readable medium” can be any means that can store, communicate, propagate, or transport the program for use by or in connection with the instruction execution system, apparatus, or device. The computer readable medium can be, for example but not limited to, an electronic, magnetic, optical, electromagnetic, infrared, or semiconductor system, apparatus, device, or propagation medium. More specific examples (a non-exhaustive list) of the computer-readable medium would include the following: an electrical connection (electronic) having one or more wires, a portable computer diskette (magnetic), a random access memory (RAM) (electronic), a read-only memory (ROM) (electronic), an erasable programmable read-only memory (EPROM, EEPROM, or Flash memory) (electronic), an optical fiber (optical), and a portable compact disc read-only memory (CDROM) (optical). Note that the computer-readable medium could even be paper or another suitable medium upon which the program is printed, as the program can be electronically captured, via for instance optical scanning of the paper or other medium, then compiled, interpreted or otherwise processed in a suitable manner if necessary, and then stored in a computer memory.

In exemplary embodiments, where the buddy list generation methods are implemented in hardware, the buddy list generation methods described herein can implemented with any or a combination of the following technologies, which are each well known in the art: a discrete logic circuit(s) having logic gates for implementing logic functions upon data signals, an application specific integrated circuit (ASIC) having appropriate combinational logic gates, a programmable gate array(s) (PGA), a field programmable gate array (FPGA), etc.

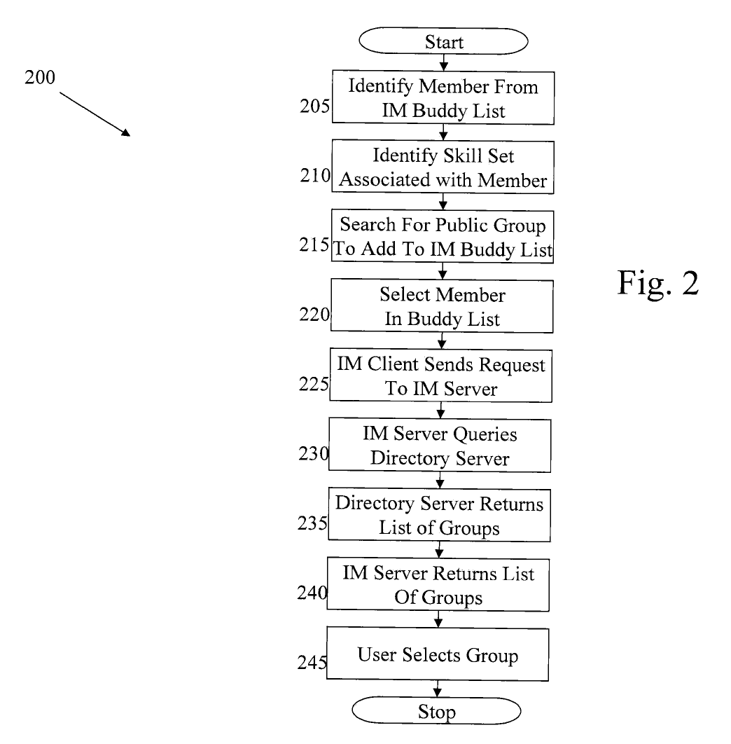

FIG. 2 illustrates a flow chart of a method 200 for building a user's buddy list through public group membership. At block 205, an IM user identifies a member from the user's buddy list. In exemplary embodiments, the IM user can be searching for a public group to add to the user's IM buddy list. In exemplary embodiments, the user may already have “Joe Smith” is in the user's buddy list and knows that Joe Smith has skill XYZ. As such, at block 210, the user identifies a particular skill associated with the member Joe Smith. At block 215, the user searches for a group of people with skill XYZ in order to have a backup for Joe Smith when Joe Smith is off-line or busy. At block 220, the user selects “Joe Smith” in the buddy list and chooses an exemplary option to show all public groups which Joe is a member as further described herein. At block 225, the IM client (e.g., the computer 101) sends a request to the IM server 170 to obtain the list of groups for the specified user. As such, the search request includes returning all groups in which Joe Smith is a member. At block 230, The IM server 170 queries the directory server 180, which may be an LDAP server as described herein. In exemplary embodiments, in the case of the LDAP server, a simple LDAP search command can be sent to the LDAP server, in which the following commands are examples:

ldapsearch -h spot.ibm.com
(&(ObjectClass=groupOfUniqueNames)(uniquemember=“uid=L111111111,c=us,ou=spot, o=ibm.com”))
or
ldapsearch -h spot.ibm.com mail=user-user@us.ibm.com ibm-allgroups

The above-referenced examples are in the general form Ldapsearch -h <hostname><filter><attributes to return> for a LDAP server. The first above referenced example is a search setting the filter to a search that looks in all groups in the directory, and the LDAP returns the groups to which the member belongs. In the second example, a search for performance is conducted. In some LDAP directories, there is an attribute in the user's person record that has all the groups of which the user is a member. As such, the filter is a search to find the actual user, and attributes are specified to return as the attribute that contains all the groups to which the user belongs. For a particular host, the filter would read: host-allgroups. For an active directory, the filter would read: memberOf.

Referring still to FIG. 2, at block 235, the directory server 180 returns to the IM server 170, a list of groups in which Joe Smith is a member. At block 240, the IM server 170 returns the list of groups to the IM client, which displays the list of groups to the user on the display 130. At block 245, the user selects the public group that the wants to add to the user's buddy list. In this example, it is “Group XYZ”. The user is now able to view all members of “Group XYZ” and has a choice of alternate people to contact when Joe is off-line or busy. The resulting groups are then returned to the user conducting the search. The user may elect to add the public group to the contact list or search for new public groups based on the users listed in the result set.

It is appreciated that all the groups that are returned for a particular user won't necessarily be the desired group. For example, several groups returned may include: Software Group; Lotus Support; Support; and Portal integration. As such, a user wanting to chat with the member would do so with a Portal Integration question, or possibly a general Support question. The user obtaining the results of the groups to which the member belongs, would logically decide what group to add to their buddy list. If they typically ask the member Portal Integration questions, then they would add the Portal Integration, if they typically ask Software Support questions, Lotus Support or Support would be the likely choice.

The capabilities of the present invention can be implemented in software, firmware, hardware or some combination thereof.

As one example, one or more aspects of the present invention can be included in an article of manufacture (e.g., one or more computer program products) having, for instance, computer usable media. The media has embodied therein, for instance, computer readable program code means for providing and facilitating the capabilities of the present invention. The article of manufacture can be included as a part of a computer system or sold separately.

Additionally, at least one program storage device readable by a machine, tangibly embodying at least one program of instructions executable by the machine to perform the capabilities of the present invention can be provided.

The flow diagrams depicted herein are just examples. There may be many variations to these diagrams or the steps (or operations) described therein without departing from the spirit of the invention. For instance, the steps may be performed in a differing order, or steps may be added, deleted or modified. All of these variations are considered a part of the claimed invention.

While the preferred embodiment to the invention has been described, it will be understood that those skilled in the art, both now and in the future, may make various improvements and enhancements which fall within the scope of the claims which follow. These claims should be construed to maintain the proper protection for the invention first described.

1. In a computer system having a display, a method for building a user's buddy list through a public group membership, the method consisting of:
identifying a member from the user's buddy list;
identifying a skill possessed by the member of the user's buddy list;
searching for a group having the skill;
selecting the member from the user's buddy list;
requesting that all public groups in which the member belongs, be displayed on the display, including sending a request to an instant messaging server to obtain a list having all the public groups for the member, wherein the instant message server is configured to query a Lightweight Directory Assistance Protocol server to obtain the list having the public groups for the member, the query to the Lightweight Directory Assistance Protocol Server being in the form, Ldapsearch—h<hostname><filter><attributes to return>, wherein the query can be configured to search for at least one of the member, the group and the skill;
receiving a response from the instant messaging server, the response including the list having the public groups for the member;
selecting from the list of public group including members that have the skill; and
performing at least one of adding the public group to a contact list and searching for additional public groups based on users included in the list of public groups of the member.
